(19) United States
(12) Patent Application Publication
(10) Pub. No.: US 2004/0000220 A1
(43) Pub. Date: Jan. 1, 2004

(54) Hand tool with operator relief feature

(76) Inventor: Leonard M. Walsh, Forestville, CT (US)

Correspondence Address: PRATT & WHITNEY, 400 MAIN STREET, MAIL STOP: 132-13, EAST HARTFORD, CT, 06108, US

(21) Appl. No.: 10/606,032

(22) Filed: Jun. 25, 2003

Related U.S. Application Data
(60) Provisional application No. 60/319,369, filed on Jun. 28, 2002.

(51) Int. Cl. B25B 7/14

(52) U.S. Cl. 81/324

(57) ABSTRACT

A hand tool, comprising: first and second members, each having a jaw at one end and a handle at an opposite end, the members pivotable between an open position and a closed position; and a retainer for selectively maintaining the members in the closed position. The hand tool could be a plier tool with a pivot pin connecting the members and enabling the members to pivot between the open and closed positions. A method of securing a clamp to an object, comprising the steps of: providing an object; providing a flexible clamp; placing the clamp on the object; actuating the hand tool to draw ends of the clamp towards each other to reduce a gap therebetween; actuating the retainer on the hand tool to keep the reduced gap; providing a fastener; securing the ends together with the fastener; and releasing the tool from the clamp.

### CROSS-REFERENCE TO RELATED APPLICATIONS

This Application claims the benefit of U.S. Provisional Patent Application No. 60/319,369 filed on Jun. 28, 2002, herein incorporated by reference.

### BACKGROUND OF THE INVENTION

This invention relates to hand tools. Specifically, the invention relates to a plier tool with an operator relief feature.

The process of securing a clamp to a wire harness can produce ergonomic issues. The potential for ergonomic issues increases as the diameter of the wire harness increases (i.e. larger clamps) and as the length of the wire harness increases (i.e. more clamps to install).

One typical installation of the clamp requires the installer to: (1) compress the clamp with a hand tool, such as a needle nose pliers; (2) continue applying the compression force to the clamp until the clamp achieves a set state; (3) discontinue applying the compression force to the clamp; (4) attach fasteners to the clamp; and (5) tighten the fasteners with suitable tools. While tightening the fasteners, the user may have to compress the clamp further with the tools to engage the fasteners.

For example, a typical wire harness clamp requires the user to apply approximately 12 pounds of force to the hand tool. Continuously applying such a compression force to the clamp can quickly tire the installer. Repeated applications of such compression forces (i.e. installing multiple clamps) can also tire the installer.

Other practices include the use of small clips to keep the clamp in a compressed state or to secure the fastener to the clamp. The use of such small clips is not preferred. The clips have a tendency to fail. The clips also become foreign object debris (FOD) if not removed properly.

### BRIEF SUMMARY OF TH INVENTION

It is an object of the present invention to provide an ergonomic hand tool.

It is a further object of the present invention to provide a hand tool that better assists a user when securing a clamp to an object.

It is a further object of the present invention to provide hand tool that is inexpensive.

It is a further object of the present invention to provide a hand tool that does not require the user to apply a continuous compression force while securing a clamp to an object.

It is a further object of the present invention to provide a hand tool that retains a compression force despite release by the user.

These and other objects of the present invention are achieved in one aspect by a hand tool, comprising: first and second members, each having a jaw at one end and a handle at an opposite end, said members pivotable between an open position and a closed position; and a retainer for selectively maintaining said members in said closed position.

These and other objects of the present invention are achieved in another aspect by a plier tool, comprising: first and second members, each having a jaw at one end and a handle at an opposite end; a pivot pin connecting said members and enabling said members to pivot between an open position and a closed position; and a retainer for selectively maintaining said members in said closed position.

These and other objects of the present invention are achieved in another aspect by a method of securing a clamp to an object, comprising the steps of: providing an object; providing a flexible clamp having two ends with a gap therebetween; placing said clamp on said object; providing a hand tool with a retainer thereon; actuating said tool to draw said ends of said clamp towards each other to produce a reduced gap therebetween; actuating said retainer to keep said reduced gap; providing a fastener; securing said ends together with said fastener; and releasing said tool from said clamp.

### BRIEF DESCRIPTION OF THE DRAWINGS

Other uses and advantages of the present invention will become apparent to those skilled in the art upon reference to the specification and the drawings, in which:

FIG. 1 is a perspective view of one embodiment of a hand tool of the present invention in an open position;

FIG. 2 is a perspective view of the hand tool of FIG. 1 in a closed position;

FIG. 3 is an exploded perspective view of the hand tool of FIG. 1; and

FIG. 4 is a perspective view of the hand tool of FIG. 1 while securing a clamp to a wire harness.

### DETAILED DESCRIPTION OF THE INVENTION

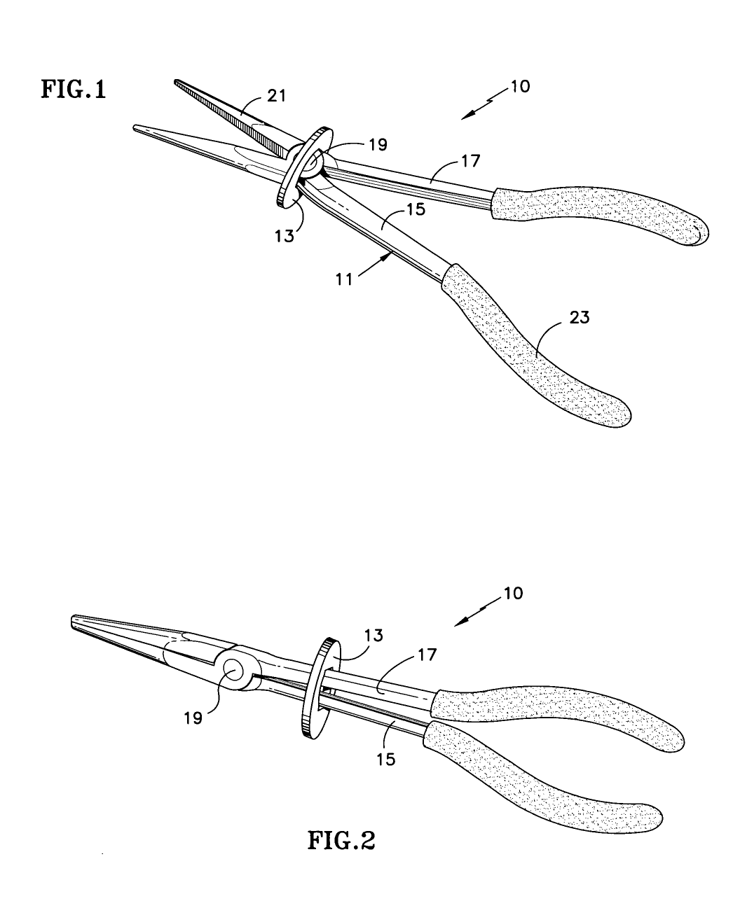

FIG. 1 displays a hand tool assembly 10 of the present invention. The assembly 10 includes a hand tool 11 and a movable retainer 13.

The hand tool 11 could be a conventional needle nose plier. The tool 11 has first and second members 15, 17 secured together by a pivot pin 19. Each member 15, 17 has a jaw 21 at one end and a handle 23 at an opposite end. The user can position the members 15, 17 of tool 11 in any arrangement between the open position shown in FIG. 1 and the closed position shown in FIG. 2.

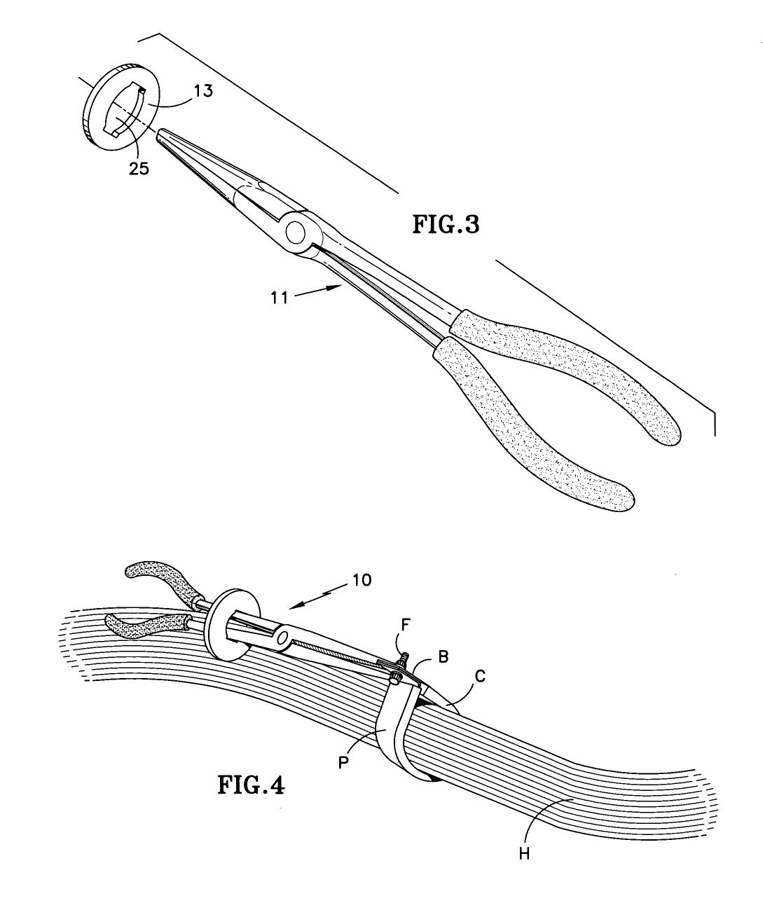

The retainer 13 can have an annular shape. Preferably, the retainer 13 is a washer with a central opening 25 through which the tool 11 extends. As seen in FIG. 3, the central opening 25 can have a shape corresponding to the shape of the handles 23 of the tool 11. Using a washer as the retainer 13 has clear cost benefits. The washer could be made from any suitable material (such as metal) or have any suitable coating (such as black oxide).

The retainer 13 is preferably sized large enough for easy manipulation by the user. The user preferably places the retainer 13 near the pivot pin 19 during operation of the tool 11 so as not to interfere with the tool 11. Once in the desired position, the user can then move the retainer 13 as desired. In the closed position, the retainer 13 could reside away from the pivot pin 19 at a location along the handles 23.

FIG. 3 shows that the retainer 13 could separate from the tool 11 by closing the jaws 21. Alternatively, the tool 11 could have a stop (not shown) added thereon to prevent removal of the retainer 13 from the tool 11.

The use of the assembly 10 to secure a clamp C to a wire harness H will now be described with reference to FIGS. 1 and 4. The clamp C includes a metallic band B surrounded by a protective covering P such as rubber. Opposite ends of the band B include openings to receive fasteners F. The fasteners F help tighten the band B around the wire harness H.

The installer places the clamp C over the wire harness H. At this point, the opposite ends of the band B have a gap (not shown) therebetween. The installer then manipulates the tool 11 to the open position shown in FIG. 1 and places the opposite ends of the band B between the jaws 21.

The installer actuates the tool 11 to draw the opposite ends of the band B towards each other. This reduces or eliminates the gap between the opposite ends of the band B.

Differently than with conventional techniques, the installer now uses the retainer 13 to provide the continuous compression force to the tool 11 for the subsequent step of installing the fasteners. As seen in FIG. 3, the handles diverge travelling away from the pivot pin. Therefore, the retainer 13 can always provide a compressive force to the tool 11. The installer merely has to move the retainer 13 away from the pivot pin 19 until the central opening 25 abuts the handles 23.

In this new position, such as shown in FIG. 4, the retainer 13 (not the installer) now provides the compression force to the tool 11. The operator can proceed to attach the fasteners, such as a nut and bolt, to the clamp C without also having to provide a compressive force to the tool 11.

After tightening the fasteners F, the installer can release the compressive force on the tool 11 by moving the retainer 13 towards the pivot pin 19. Once the central opening 25 clears the handles 23, the tool 11 can open.

The present invention has been described in connection with the preferred embodiments of the various figures. It is to be understood that other similar embodiments may be used or modifications and additions may be made to the described embodiment for performing the same function of the present invention without deviating therefrom. For example, the present invention could have applications other than with wire harnesses. For example, the present invention could be used to clamp pipes to an object. The present invention could be used to grasp a leg of a cotter pin while bending the leg into position. Finally, the present invention could also be used to hold objects (e.g. a terminal and wire) undergoing a soldering operation. Therefore, the present invention should not be limited to any single embodiment, but rather construed in breadth and scope in accordance with the recitation of the appended claims.

1. A hand tool, comprising:
first and second members, each having a jaw at one end and a handle at an opposite end, said members pivotable between an open position and a closed position; and
a retainer for selectively maintaining said members in said closed position.

2. The tool as recited in claim 1, wherein said retainer surrounds said members.

3. The tool as recited in claim 1, wherein said retainer can travel from an inoperative position to an operative position in a direction from said jaws to said handles.

4. The tool as recited in claim 3, wherein said retainer surrounds said handles when at said operative position.

5. The tool as recited in claim 3, wherein said members rotate around a pivot pin, and said retainer resides adjacent said pivot pin when at said inoperative position.

6. The tool as recited in claim 1, wherein said retainer is annular.

7. The tool as recited in claim 6, wherein said retainer is a washer.

8. A plier tool, comprising:
first and second members, each having a jaw at one end and a handle at an opposite end;
a pivot pin connecting said members and enabling said members to pivot between an open position and a closed position; and
a retainer for selectively maintaining said members in said closed position.

9. The tool as recited in claim 8, wherein said plier tool is a needle nose plier tool.

10. The tool as recited in claim 8, wherein said retainer surrounds said members.

11. The tool as recited in claim 8, wherein said retainer can travel from an inoperative position to an operative position in a direction from said jaws to said handles.

12. The tool as recited in claim 11, wherein said retainer surrounds said handles when at said operative position.

13. The tool as recited in claim 11, wherein said retainer resides adjacent said pivot pin when at said inoperative position.

14. The tool as recited in claim 8, wherein said retainer is annular.

15. The tool as recited in claim 14, wherein said retainer is a washer.

16. A method of securing a clamp to an object, comprising the steps of:
providing an object;
providing a flexible clamp having two ends with a gap therebetween;
placing said clamp on said object;
providing a hand tool with a retainer thereon;
actuating said tool to draw said ends of said clamp towards each other to produce a reduced gap therebetween;
actuating said retainer to keep said reduced gap;
providing a fastener;
securing said ends together with said fastener; and
releasing said tool from said clamp.

17. The method as recited in claim 16, wherein said hand tool is a plier tool.

18. The method as recited in claim 17, wherein said plier tool is a needle nose plier tool.

19. The method as recited in claim 18, wherein said retainer is an annular element surrounding said tool.

20. The method as recited in claim 16, wherein said object is a wire harness.
